(19) United States
(12) Patent Application Publication
(10) Pub. No.: US 2015/0154132 A1
(43) Pub. Date: Jun. 4, 2015

(54) SYSTEM AND METHOD OF ARBITRATION ASSOCIATED WITH A MULTI-THREADED SYSTEM

(71) Applicant: SANDISK TECHNOLOGIES INC., PLANO, TX (US)

(72) Inventors: DANIEL EDWARD TUERS, KAPAA, HI (US); YOAV WEINBERG, THORNHILL (CA); ABHIJEET MANOHAR, BANGALORE (IN); YOSIEF ATAKLTI, FREMONT, CA (US)

(73) Assignee: SANDISK TECHNOLOGIES INC., PLANO, TX (US)

(21) Appl. No.: 14/199,840

(22) Filed: Mar. 6, 2014

Related U.S. Application Data
(60) Provisional application No. 61/910,849, filed on Dec. 2, 2013.

(30) Foreign Application Priority Data
Feb. 4, 2014 (IN) 520/CHE/2014

(51) Int. Cl. G06F 13/30; G06F 13/37

(52) U.S. Cl. CPC G06F 13/30; G06F 13/37

(57) ABSTRACT

A data storage device includes a controller coupled to a non-volatile memory via a data path element. The controller includes a first queue that includes a first set of requests and a second queue that includes a second set of requests. The controller further includes logic configured to assign a particular request from the first queue or from the second queue to have access to the data path element. When the logic is in a first mode, the logic selects a particular request is selected based on an arbitration scheme applied to the first queue and the second queue. When the logic is in a second mode, the logic selects a prioritized request from the first set of requests or the second set of requests independently of the arbitration scheme.

### REFERENCE TO EARLIER-FILED APPLICATIONS

This application claims priority from U.S. Provisional Patent Application No. 61/910,849, filed Dec. 2, 2013, and from Indian Application No. 520/CHE/2014, filed Feb. 4, 2014. The contents of each of these applications are incorporated by reference herein in their entirety.

### FIELD OF THE DISCLOSURE

The present disclosure is generally related to arbitration associated with a multi-threaded system.

### BACKGROUND

Non-volatile data storage devices, such as embedded memory devices (e.g., embedded MultiMedia Card (eMMC) devices) and removable memory devices (e.g., removable universal serial bus (USB) flash memory devices and other removable storage cards), have allowed for increased portability of data and software applications. Users of non-volatile data storage devices increasingly rely on non-volatile storage devices to store and provide rapid access to a large amount of data. For example, a user may store large audio files, images, videos, and other files at a data storage device.

Non-volatile data storage devices may include a multi-threaded system where requests and/or data are processed or communicated in parallel. Multiple threads of the multi-threaded system may use a shared resource (e.g., a restricted resource, such as a data bus) that limits use to less than all of the multiple threads to access the shared resource at one time. To manage access of the multiple threads to the shared resource, the non-volatile data storage device may implement an arbitration scheme to determine which of the multiple threads may access the shared resource during a particular time period. However, as complexity of non-volatile data storage devices increases, arbitration schemes implemented by the non-volatile data storage devices may not utilize the shared resource as efficiently as possible. For example, in certain situations, an arbitration scheme may result in the shared resource being idle while one or more threads are ready to access the shared resource, or the arbitration scheme may result in requests and/or data backing up in a queue while waiting to access the shared resource.

### SUMMARY

Techniques are disclosed for arbitrating access to a shared resource in a multi-threaded system. Requests (e.g., shared resource requests) seeking access to the shared resource may have a corresponding order number associated with an order, such as a sequential order. Additionally, one or more of the requests may be identified as a priority request. For example, a particular request may include an indicator, such as a flag, that is set to identify the particular request as a priority request. The indicator may be set for the particular request based on various factors, such as an amount time (e.g., a transmit time) the particular request takes to be communicated via the shared resource and/or based on an amount of data (e.g., a number of data bits) associated with communicating the particular request via the shared resource, as illustrative, non-limiting examples. As an example, the indicator may be set for the particular request when the amount of time the particular request takes to be communicated via the shared resource, such as an amount of time that the shared resource is allocated to the particular request, is less than a threshold amount of time. As another example, the indicator may be set for the particular request when a number of data bits to be communicated, based on the particular request, via the shared resource is less than a threshold number of data bits.

Each thread of the multi-threaded system may be associated with a corresponding queue that stores requests that are seeking access to the shared resource. When one or more queues of multiple queues provides a corresponding indication that the queue(s) is ready to provide a request to the shared resource, the multi-threaded system may use one or more arbitration schemes to determine which queue is permitted to provide a request to the shared resource based on the order numbers, one or more indicators, or a combination thereof. For example, when multiple queues are each ready to provide a corresponding request to the shared resource, a first arbitration scheme (e.g., an order number scheme) may be applied. Using the order number scheme, a particular request may be selected to be provided to the shared resource based on an order number (e.g., a timestamp or a numerical value that indicates a sequential order) of each of the requests that are ready to be provided by the queues. For example, the particular request may obtain access to the shared resource before other requests when a timestamp of the particular request is earlier than timestamps of the other requests. When the multi-threaded system detects that a particular request of the requests that are ready to be provided by the queues includes a corresponding indicator (e.g., the particular request is a prioritized request), the multi-threaded system may bypass the first arbitration scheme and instead follow a second arbitration scheme. Using the second arbitration scheme, the particular request (e.g., the prioritized request) may be selected to be provided to the shared resource regardless of the order numbers of the requests that are ready to be provided by the queues. When prioritized requests are identified based on an amount of time and/or an amount of data for a particular request to be communicated via or processed by a shared resource, providing the prioritized request access to the shared resource prior to providing access to non-prioritized requests may result in increased utilization of the shared resource.

### BRIEF DESCRIPTION OF THE DRAWINGS

FIG. 1 is a block diagram of a particular illustrative embodiment of a system including a data storage device that arbitrates requests communicated via a data path element;

FIG. 2 is block diagram of a first illustrative embodiment of the data storage device of FIG. 1;

FIGS. 3A-E are timing diagrams of a illustrative embodiments of requests communicated via the data path element of FIG. 1;

FIG. 4 is a flow diagram of a first illustrative method of operating a data storage device; and

FIG. 5 is a flow diagram of a second illustrative method of operating a data storage device.

### DETAILED DESCRIPTION

Particular embodiments of the present disclosure are described below with reference to the drawings. In the description, common features are designated by common reference numbers throughout the drawings.

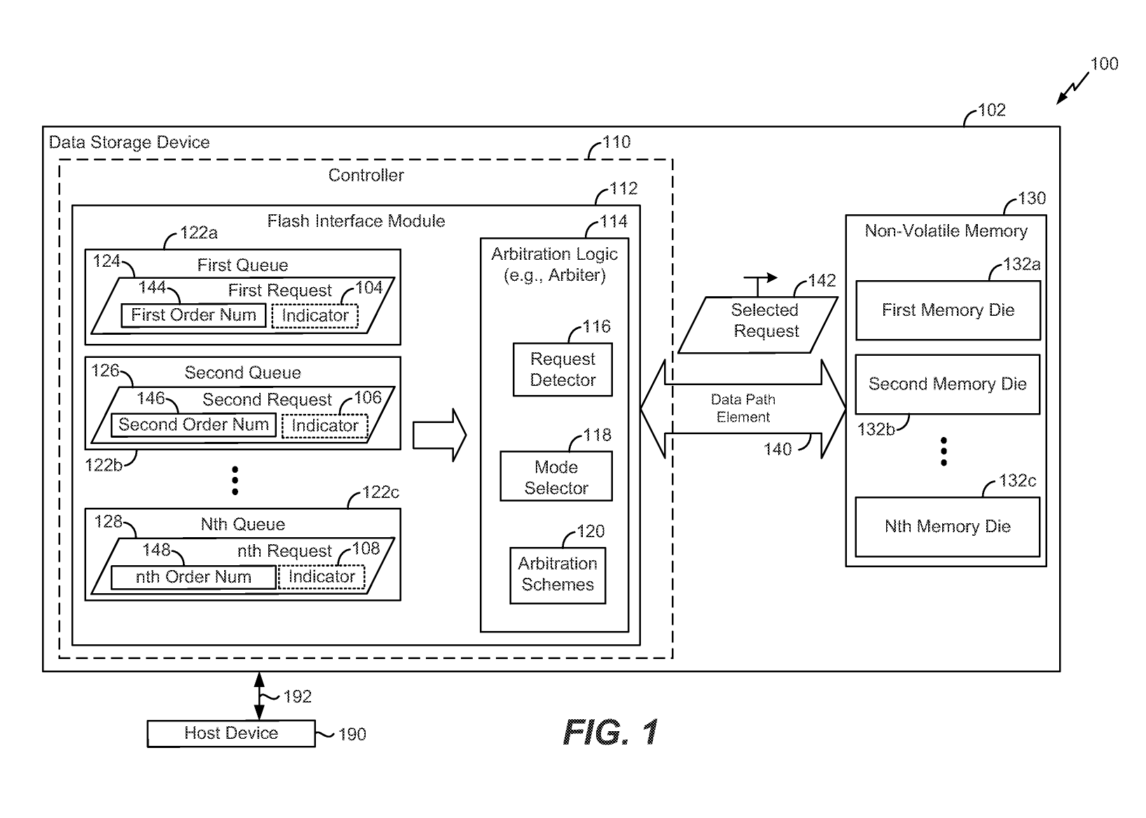

FIG. 1 depicts a particular embodiment of a system 100 that includes a host device 190 and a data storage device 102. The data storage device 102 may be coupled to the host device 190 via a communication path 192, such as a wired communication path and/or a wireless communication path. The data storage device 102 may be configured to be coupled to the host device 190 as embedded memory. Alternatively, the data storage device 102 may be removable from (i.e., “removably” coupled to) the host device 190. For example, the data storage device 102 may be removably coupled to the host device 190 in accordance with a removable universal serial bus (USB) configuration.

The host device 190 may issue one or more commands to the data storage device 102, such as one or more requests to read data from or write data to a memory (e.g., non-volatile memory 130) of the data storage device 102. The host device 190 may include a mobile telephone, a music player, a video player, a gaming console, an electronic book reader, a personal digital assistant (PDA), a computer, such as a laptop computer, a notebook computer, or a tablet, any other electronic device, or any combination thereof.

The data storage device 102 may be embedded memory in the host device 190, such as eMMC® (trademark of JEDEC Solid State Technology Association, Arlington, Va.) memory and eSD memory, as illustrative examples. To illustrate, the data storage device 102 may correspond to an embedded MultiMedia Card (eMMC) device. Alternatively, the data storage device 102 may be a memory card, such as a Secure Digital SD® card, a microSD® card, a miniSD™ card (trademarks of SD-3C LLC, Wilmington, Del.), a MultiMediaCard™ (MMC™) card (trademark of a Joint Electron Devices Engineering Council (JEDEC) Solid State Technology Association, Arlington, Va.), or a CompactFlash® (CF) card (trademark of SanDisk Corporation, Milpitas, Calif.). The data storage device 102 may operate in compliance with a Joint Electron Devices Engineering Council (JEDEC) industry specification. For example, the data storage device 102 may operate in compliance with a JEDEC eMMC specification, a JEDEC Universal Flash Storage (UFS) specification, one or more other specifications, or a combination thereof.

The data storage device 102 includes a controller 110, a data path element 140, and a non-volatile memory 130. The controller 110 may be coupled to the non-volatile memory 130 via the data path element 140 (e.g., a shared resource, such as a bus), as described further herein. The storage device 102 may include or operate using a multi-threaded system. Each thread of the multi-threaded system may be associated with a different memory die of the non-volatile memory 130 and may have a corresponding data path. To illustrate, when the non-volatile memory includes memory dies 132a-c, the multi-threaded system may include a first thread associated with a first memory die 132a, a second thread associated with a second memory die 132b, and an Nth thread associated with an Nth memory die 132c (e.g., N may be any positive integer greater than one), as illustrative, non-limiting examples. For example, requests and/or data associated with a particular thread of the multi-threaded system may propagate through the storage device 102 via a particular data path of the particular thread. The particular data path of the particular thread may include one or more components, such as one or more queues, or a memory die, that correspond to the particular thread and not to any other thread. The particular data path may further include one or more shared components (e.g., one or more shared elements) that are shared by multiple threads. For example, the data path element 140 may be a shared component. Access to a shared component may be restricted to one thread at a time and one or more arbitration schemes may be used to determine which thread may access the shared component at a particular time.

The controller 110 may include a flash interface module 112. The flash interface module 112 may include arbitration logic 114 (e.g., an arbiter) and one or more queues 122a-c, such as one or more priority queues. The one or more queues 122a-c may include a first queue 122a, a second queue 122b, and an Nth queue 122c. Although the flash interface module 112 is illustrated as including three queues 122a-c, the flash interface module 112 may include less than three or more than three queues. N may be any positive integer greater than one and may reflect a total number of queues included in the flash interface module 112. Although the queues 122a-c are illustrated as being included in the flash interface module 112, one or more of the queues 122a-c may be external to the flash interface module 112.

Each of the one or more queues 122a-c may be configured to store a corresponding set of requests, such as a set of one or more memory bus requests (e.g., one or more flash bust requests). For example, the first queue 122a may be configured to store a first set of requests that includes a first request 124 (and may include other requests not shown), the second queue 122b may be configured to store a second set of requests that includes a second request 126 (and may include other requests not shown), and the Nth queue 122c may be configured to store an Nth set of requests that includes an nth request 128 (e.g., n may be any positive integer greater than one) (and may include other requests not shown). Although each queue 122a-c is illustrated in FIG. 1 as including a single request, one or more of the queues 122a-c may include no requests, a single request, or multiple requests and the number of requests in each of the queues 122a-c may change over time during operation of the data storage device 102. Each of the one or more queues 122a-c may operate (e.g., store requests) in a first in, first out (FIFO) manner Each of the requests stored at any of the one or more queues 122a-c corresponds to operations to be performed at the non-volatile memory 130, as described further herein.

Each of the one or more queues 122a-c may correspond to a memory die included in the non-volatile memory 130. For example, the first queue 122a (associated with the first thread) may correspond to a first memory die 132a, the second queue 122b (associated with the second thread) may correspond to a second memory die 132b, and the Nth queue 122c (associated with the Nth thread) may correspond to an Nth memory die 132c. Accordingly, each set of requests stored in each of the queues 122a-c may be configured to initiate one or more operations at a corresponding memory die 132a-c. For example, the first set of requests stored at the first queue 122a may be configured to initiate one or more operations at the first memory die 132a, the second set of requests stored at the second queue 122b may be configured to initiate one or more operations at the second memory die 132b, and the Nth set of requests stored at the Nth queue 122c may be configured to initiate one or more operations at the Nth memory die 132c. To illustrate, each of the one or more operations may be a read operation, a write operation, an erase operation, a toggle operation, a hold operation, a clean-up operation, a memory access operation, or a refresh operation, as illustrative, non-limiting examples.

A particular request may be received by one of the queues 122a-c and may be based on one or more commands received from the host device 190 and/or generated internally by the data storage device 102. To illustrate, the particular request may be based on a command (e.g., an access request) received by the controller 110 from the host device 190, such as a read access request or a write access request. As another illustration, the particular request may be based on a command (e.g., an access request) generated by one or more components included in the controller 110, such as a processor, a media management unit, a command sequencer (to attach an order number to one or more commands and/or access requests), an encoder, a logical to physical mapping engine, a direct memory access (DMA) module, an error correcting code (ECC) engine, a cyclic redundancy check (CRC) engine, an encryption engine, or a decryption engine, as illustrative, non-limiting examples. For example, the one or more components may generate a clean-up command, a refresh command, or a memory access command, as illustrative, non-limiting examples.

A particular request may be stored in one of the queues 122a-c based on a physical address associated with a corresponding memory die to which the particular request is to be provided. For example, the controller 110 may be configured to perform an address translation on each of the requests to identify a physical address associated with each of the requests. To illustrate, a first physical address of the first request 124 may correspond to the first memory die 132a and, accordingly, the first request 124 may be stored in the first queue 122a.

The requests stored at the queues 122a-c may be associated with an order, such as a sequential order. For example, each of the requests 104-108 may have a corresponding order number (e.g., a corresponding order value). The first request 124 may be associated with a first order number 144, the second request 126 may be associated with a second order number 146, and the nth request 128 may be associated with an nth order number 148. The order may be based on an order in which multiple commands and/or requests were received at the controller 110 or an order in which the requests 104-108 were generated. The order number of each of the requests 104-108 may be designated based on a timestamp or a numbering system (e.g., a numerical value), as illustrative, non-limiting examples. For example, the requests 124-128 may be in an order starting with the first request 124, followed by the second request 126, and ending with the nth request 128. To illustrate, the first order number 144 may be associated with a value of one, the second order number 146 may be associated with a value of two, and the nth order number 148 may be associated with a value of n (e.g., a value greater than two).

One or more of the requests 104-108 may be associated with an indicator, such as an arbitration bypass indicator. For example, the first request 124 may be associated with a first indicator 104, the second request 126 may be associated with a second indicator 106, and the nth request 128 may be associated with an nth indicator 108. The indicator may be set or applied to a particular request by the controller 110, or a component thereof, when the particular request is generated. The indicator, when set, identifies the particular request as a prioritized request. The indicator identifying the particular request as the prioritized request is used as part of an arbitration scheme to provide the prioritized request with access to a shared resource, as described further herein.

Determining whether to set the indicator for the particular request (to identify the particular request as a prioritized request) may be based on various factors, such as an amount time (e.g., a transmit time) the particular request takes to be communicated via a shared resource and/or based on an amount of data (e.g., a number of data bits) associated with the particular request, as illustrative, non-limiting examples. As an example, the indicator may be set for the particular request when the amount of time the particular request takes to be communicated via the shared resource, such as an amount of time that the shared resource is allocated to the particular request, is less than a threshold amount of time. As another example, the indicator may be set for the particular request when a number of data bits to be communicated, based on the particular request, via the shared resource is less than a threshold number of data bits.

To illustrate, when the particular request is generated, the particular request may classified into (or identified as part of) one of at least two groups, such as a first group and a second group. Requests classified into the first group may be identified as prioritized requests and requests classified into the second group may not be identified as prioritized requests. For example, requests included in the first group may include short bus transactions that take a shorter amount of time (e.g., a transmit time) to be communicated via the shared resource (e.g., the data path element 140) than requests included in the second group. Alternatively or additionally, the requests included in the first group may have less data to be communicated via the shared resource than the requests included in the second group. For example, the requests of the first group may include requests that have a small number of bits, such as requests associated with a read command (to perform an operation to sense one or more values at a location of the non-volatile memory 130), a program check status command (to perform an operation to free a set of queues for another operation), or an erase command (to perform an operation to erase at least a block of the non-volatile memory 130), as illustrative, non-limiting examples. The requests of the second group may include requests that are associated with communicating read data or write data via the shared resource. For example, the second group may include a program request that includes write data to be written to the non-volatile memory 104 or a transfer request that requests data to be read from the non-volatile memory 104, as illustrative, non-limiting examples. Accordingly, one or more requests may be indicated as priority requests (e.g., short bus transactions, such as a read command, a check status command, or an erase command) to increase a performance characteristic (e.g., a throughput, a data rate, a utilization, etc.) of the shared resource.

As an illustrative example, the first request 124 may be identified as being associated with the first group. For example, the first request 124 may be a sense request, a program check status request, or an erase request, as illustrative, non-limiting examples. The first indicator 104 (e.g., an arbitration bypass indicator) may be set or included in the first request 124 to identify the first request 124 as a prioritized request based on the first request 124 being associated with the first group. For example, the first indicator 104 may be a flag associated with the first request 124 that is set to identify the first request 124 as a prioritized request.

When a particular queue, of the queues 122a-c, is ready to send a request to the non-volatile memory 130 via the data path element 140, the particular queue may provide an indication to the arbitration logic 114. To illustrate, when the first queue 122a stores the first request 124, the first queue 122a may provide an indication that the first queue 122a is ready to send the first request 124 to the non-volatile memory 130. For example, the first queue 122a may provide an order number associated with the first request 124 to the arbitration logic 114 to indicate that the first queue 122a is ready to send the first request 124 to the non-volatile memory 130, as further described herein. Additionally, the first queue 122a may indicate to the arbitration logic 114 whether the first request 124 includes the first indicator 104 (and/or whether the first indicator 104 is set).

The arbitration logic 114 is configured to select a request from one of the queues 122a-c and to provide the selected request 142 access to the shared resource (e.g., the data path element 140). For example, during a particular time period, the arbitration logic 114 is configured to assign a request from the first queue 122a, the second queue 122b, or the Nth queue 122c to have access to the data path element 140. The arbitration logic 114 may select (e.g., assign) the particular request based on an arbitration scheme associated with the arbitration logic 114, as described further herein. The arbitration logic 114 may be implemented as hardware, software, firmware, or a combination thereof. For example, the arbitration logic 114 may be implemented by a processor that executes one or more instructions stored at a memory, such as the non-volatile memory 130 or a memory (e.g., a random access memory (RAM)) of the controller 110.

The arbitration logic 114 includes a request detector 116, a mode selector 118, and one or more arbitration schemes 120. The request detector 116 is configured to detect when one or more of the queues 122a-c is ready to provide a request to the non-volatile memory 130. For example, the request detector 116 may detect that a particular queue is ready to send a particular request based on the particular queue providing an order number of the particular request to the request detector 116. Additionally or alternatively, the request detector 116 may determine whether the particular request includes an indicator, such as an arbitration bypass indicator, indicating that the particular request is a prioritized request. For example, the request detector 116 may determine whether the first request 124 of the first queue 122a includes or associated with the first indicator 104 (i.e., the first indicator 104 is set to indicate that the first request 124 is prioritized). To illustrate, the request detector 116 may detect the first indicator 104 based on a flag associated with the first request 124, based on a signal received from the first queue 122a, or based on a signal received from a component (e.g., a register) of the controller 110 that tracks prioritized requests, as illustrative, non-limiting examples.

The arbitration schemes 120 may include a greedy algorithm scheme, a first in, first out (FIFO) scheme, a round robin scheme, a static priority scheme, a dynamic priority scheme, a time slicing scheme, or an order number scheme, as illustrative, non-limiting examples. Each of the arbitration schemes 120 may be used by the arbitration logic 114 to assign requests from the queues 122a-c to the data path element 140. For example, the arbitration logic 114 may be configured to implement multiple arbitration schemes or a single arbitration scheme.

The mode selector 118 may be configured to select one or more modes (e.g., one or more arbitration modes) to be used by the arbitration logic 114. The mode selector 118 may select a particular mode based in part on whether the request detector 116 detected that any of the queues 122a-c is ready to provide at least one prioritized request. For example, the mode selector 118 may receive a signal from the request detector 116 in response to the request detector 116 detecting a prioritized request and selects a bypass mode based on the signal.

To illustrate, the mode selector 118 may select a first mode that corresponds to a first arbitration scheme. The first mode may be associated with an initial mode and/or a default mode of the arbitration logic 114. When multiple queues of the one or more queues 122a-c are ready to provide a corresponding request, the arbitration logic 114 in the first mode may pick a particular request from the multiple queues based on the first arbitration scheme. The first arbitration scheme may be an order number scheme, as an illustrative, non-limiting example. When the arbitration logic 114 operates according to the order number scheme, the arbitration logic 114 makes a selection of a particular request from the queues 122a-c based on an order number (e.g., a timestamp or a numerical value that indicates a sequential order) of each of the requests that are ready to be provided by the queues 122a-c.

Based on the request detector 116 detecting that at least one of the requests 104-108 that are ready to be provided by the queues 122a-c is a prioritized request, the mode selector 118 selects a second mode. For example, the mode selector 118 may switch from the first mode to the second mode in response to the request detector 116 detecting the prioritized request. The second mode may be a bypass mode that is distinct from the first arbitration scheme of the first mode. The bypass mode enables the arbitration logic 114 to make a selection of the particular request (e.g., the prioritized first request 124) by bypassing the order numbers of the requests 104-108 and by selecting a prioritized request (e.g., the first request 124) from the queues 122a-c. For example, in the second mode, the arbitration logic 114 selects a prioritized request to receive access to the data path element 140. The prioritized request is selected independent of the arbitration scheme of the first mode. By bypassing the first arbitration scheme when one or more of the requests 104-108 that are ready to be provided by the queues 122a-c is a prioritized request, the prioritized requests are selected before other requests that are not prioritized requests. When prioritized requests, such as requests that are quickly transmitted or that are accompanied by little or no read/write data, are selected to be allocated to access the data path element 140 prior to non-prioritized requests that are ready to be provided by the queues 122a, utilization of the shared resource (i.e., the data path element 140) may increase.

The data path element 140 is a shared resource (e.g., a restricted resource) that is shared by the queues 122a-c (e.g., by multiple threads). For example, the data path element 140 may be a bus, such as a data bus (e.g., a NAND bus). The data path element 140 (e.g., the bus) couples the flash interface module 112 to the non-volatile memory 130. The bus is configured to enable communication between the controller 110 and one or more memory dies 132a-c of the non-volatile memory 130, and the bus is shared among the memory dies 132a-c.

The data storage device 102 may include other shared resources in addition to the data path element 140, such as a processor, a media management unit, an encoder, a logical to physical mapping engine, a direct memory access (DMA) module, an error correcting code (ECC) engine, a cyclic redundancy check (CRC) engine, an encryption engine, a decryption engine, and/or components of any of the above, as illustrative, non-limiting examples. Each of the shared resources may include multiple queues associated therewith that each corresponds to a different thread of the multi-threaded system of the data storage device 102. Each of the other shared resources may arbitrate between multiple requests stored in the multiple queues to select a particular request to be provided to and/or processed by the other shared resource at any particular time. To illustrate, an encoder included in the controller 110 may include or may be associated with multiple encoder queues that include one or more requests to be processed by the encoder. The encoder may select a particular request, during a particular time period, from the multiple queues of the encoder and process the request to produce one or more requests configured to be provided the non-volatile memory 130.

The non-volatile memory 130 may include a memory array, such as a memory array including multiple flash dies 132a-c. For example, the multiple flash dies 132a-c may include a first memory die 132a, a second memory die 132b, and an Nth memory die 132c. Although the non-volatile memory 130 is illustrated as including three memory dies, the non-volatile memory 130 may include less than three or more than three memory dies.

The non-volatile memory dies 132a-c may include one or more types of storage media, such as a flash memory, a one-time programmable memory, other memory, or any combination thereof. In a particular embodiment, the non-volatile memory 130 includes a flash memory (e.g., NAND, NOR, Multi-Level Cell (MLC), Divided bit-line NOR (DINOR), AND, high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory. In a particular embodiment, the plurality of memory dies 132a-c includes a plurality of NAND flash devices.

The memory dies 132a-c may perform one or more operations based on requests received from the controller 110 via the data path element 140. For example, the multiple dies 132a-c may share the data path element 140 and two or more dies of the memory dies 132a-c may perform operations concurrently.

During operation of the data storage device 102, the queues 122a-c may each receive a corresponding set of one or more requests. The request detector 116 may determine that one or more of the queues 122a-c is ready to provide a corresponding request to the non-volatile memory 130 via the data path element 140. For example, the request detector 116 may determine that the first queue 122a is ready to provide the first request 124 and that the second queue 122b is ready to provide the second request 126.

The request detector 116 may determine whether the first request 124 or the second request 126 is a prioritized request (e.g., a prioritized request associated with an arbitration bypass indicator). For example, the request detector 116 may determine whether the first request 124 is a prioritized request based on whether the first indicator 104 is set. As another example, the request detector 116 may determine whether the second request 126 is a prioritized request based on whether the second indicator 106 is set.

When the first request 124 and the second request 126 are unprioritized requests, the arbitration logic 114 operates in accordance with a first mode. Based on the first mode, the arbitration logic 114 selects a particular request to be provided via the data path element 140 based on an arbitration scheme applied to the first queue and the second queue. For example, the arbitration logic 114 may select the first request 124 or the second request 126, using the order number scheme, based on a first order number of the first request 124 and based on a second order number of the second request 126. For example, when the first order number has a lower value than the second order number, the first request 124 may be selected prior to the second request 126.

When the first request 124 and/or the second request 126 is a prioritized request, the mode selector 118 selects a bypass mode of operation for the arbitration logic 114. In the bypass mode, the arbitration logic 114 selects a prioritized request to have access to the data path element 140 over one or more non-prioritized requests. For example, when the first request 124 is a prioritized request (e.g., the first indicator 104 is set) and the second request 126 is not a prioritized request, the arbitration logic 114 in the bypass mode selects the first request 124 to have access to the data path element 140 regardless of an order of the first request 124 and the second request 126. To illustrate, when in the bypass mode, the arbitration logic 114 selects the first request 124 (e.g., the prioritized request) prior to the second request 126 even if the second request 126 would be selected prior to the first request 124 using the order number scheme (e.g., the first arbitration scheme).

As another example, when the second request 126 is a prioritized request (e.g., the second indicator 106 is set) and the first request 124 is not a prioritized request, the arbitration logic 114 in the bypass mode selects the second request 126 to have access to the data path element 140. As a further example, when the first request 124 and the second request 126 are both prioritized requests, the arbitration logic may select one of the first request 124 or the second request 126 to have access to the data path element 140 based on the arbitration scheme as applied to the first request 124 and the second request 126 (e.g., the first order number of the first request 124 and based on the second order number of the second request 126). To illustrate, when the arbitration scheme is applied by the arbitration logic 114 to multiple prioritized requests, requests that are not prioritized requests are not considered for selection by the arbitration logic 144.

By selecting a mode of operation for the arbitration logic 114 based on whether at least one of the requests 104-108 is a priority request, the arbitration logic 114 selects prioritized requests over non-prioritized requests. When the prioritized requests are identified based on an amount of time and/or an amount of data for a particular request to be communicated via or processed by a shared resource, providing the prioritized request over non-prioritized requests results in increased utilization of the shared resource.

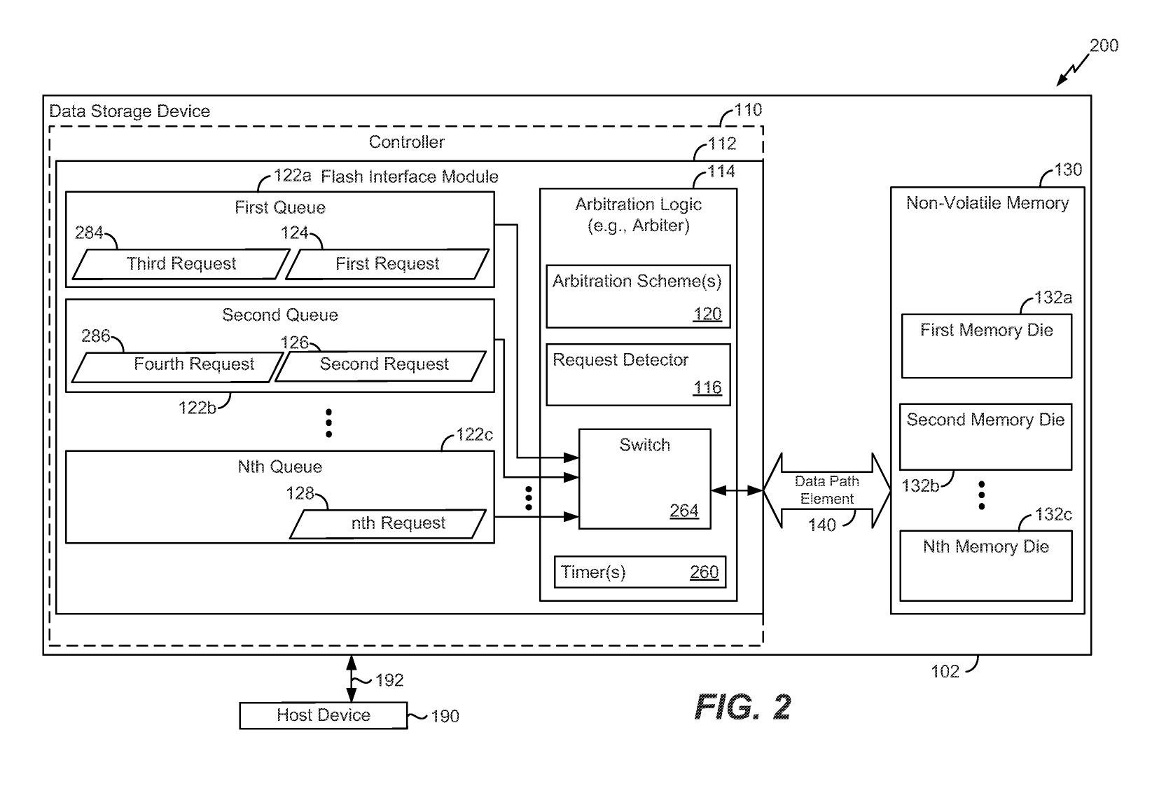

Referring to FIG. 2, a particular illustrative embodiment of a system 200 is depicted that includes the data storage device 102 of FIG. 1. Certain components and operations of the system 200 of FIG. 2 are described with reference to the system 100 of FIG. 1. The data storage device 102 may include the controller 110, the data path element 140, and the non-volatile memory 130. The non-volatile memory 130 includes the memory dies 132a-c.

The controller 110 may include the flash interface module 112 that is coupled to the non-volatile memory 130 via the data path element 140. The flash interface module 112 may include the queues 122a-c, such as the first queue 122a, the second queue 122b, and the Nth queue 122c. The first queue 122a may store a first set of requests (e.g., a set of bus requests) that includes the first request 124 and a third request 284. The second queue 122b may store a second set of requests that includes the second request 126 and the fourth request 286. The Nth queue 122c may store an Nth set of requests that includes the nth request 128.

Each of the one or more queues 122a-c may be a first in, first out (FIFO) queue. Accordingly, the first queue 122a may receive the first request 124 followed by the third request 284 and may output the first request 124 prior to the third request 284. Each of the requests 124-128, 284-286 may be associated with an order (e.g., a sequential order) and may include a corresponding order number indicating a position in the order. For example, the positions of the requests 124-128, 284-286 in the order may be the first request 124, followed by the second request 126, followed by the third request 284, followed by the fourth request 286, followed by the nth request 128. One or more of the requests 124-128, 284-286 included in the queues 122a-c may include a corresponding indicator (e.g., a bypass indicator), such as the indicators 104-108 of FIG. 1, to indicate that the request is a prioritized request.

The arbitration logic 114 may include the one or more arbitration schemes 120, the request detector 116, a switch 264, and one or more timers 260. The arbitration logic 114 may operate in accordance with the arbitration schemes 120. The switch 264 may be configured to selectively couple one of the queues 122a-c to the data path element 140. For example, when the arbitration logic 114 selects the first request 124 to have access to the data path element 140, the switch 264 may couple the first queue 122a to the data path element 140. When the arbitration logic 114 selects the second request 126, the switch 264 may couple the second queue 122b to the data path element 140. The timer 260 may be configured to determine whether a particular request that is ready to be provided by one of the queues 122a-c is in a hold status (e.g., a prohibited status), as described further herein. When a particular request is in the hold status, the arbitration logic 114 may be prohibited from selecting to access the data path element 140. For example, the arbitration logic 114 may be prohibited from considering the particular request regardless of an order number of the particular request and/or regardless of whether the particular request is a prioritized request.

The arbitration schemes 120 may enable the arbitration logic 114 (e.g., an arbiter) to select a particular request from the queues 122a-c. For example, a first arbitration scheme may be an order number scheme. When the arbitration logic 114 applies the order number scheme, the arbitration logic 114 may select the particular request from multiple requests that are ready to be provided by one or more of the queues 122a-c based on corresponding order numbers of each of the multiple requests. A second arbitration scheme may be a prioritized arbitration scheme. When the arbitration logic 114 applies the prioritized arbitration scheme, the arbitration logic 114 may select a request from the multiple requests that are ready to be provided by the queues 122a-c based on one or more of the multiple requests being a prioritized request.

A third arbitration scheme may be associated with selecting a particular request followed by selecting a next request (e.g., a next request selected after the particular request) from the same queue (e.g., from the same thread) that the particular request was selected from. To illustrate, when the arbitration logic 114 applies the third arbitration scheme, the arbitration logic 114 may select the first request 124 from the first queue 122a. After selecting the first request 124, the request detector 116 may determine whether the first queue 122a includes another request, such as the third request 284, that may be ready to be provided by the first queue 122a after the first request 124. If the first queue 122a is not ready to provide another request, the arbitration logic 114 may select a next request based on another arbitration scheme, such as the first arbitration scheme or the second arbitration scheme. If the first queue 122a is ready to provide another request, the arbitration logic 114 may select the other request from the first queue 122a. The other request may be selected from the first queue 122a regardless of another arbitration scheme, such as the first arbitration scheme or the second arbitration scheme, as illustrative, non-limiting examples. By selecting the other request from the same queue as the previous request, the switch 264 may not have to operate to switch between queues (e.g., between threads).

As an illustrative example, the third arbitration scheme may be applied based on the arbitration logic 114 selecting a prioritized request. When the arbitration logic 114 applies an arbitration scheme other than the third arbitration scheme, such as the first arbitration scheme or the second arbitration scheme, and selects a prioritized request, the arbitration logic 114 may apply the third arbitration scheme to determine a next request to be selected after the prioritized request. For example, when the first request 124 is the prioritized request and the arbitration logic 114 selects the first request 124 from the first queue 122a, the arbitration logic 114 may apply the third arbitration scheme to determine whether the first queue 122a includes another request that is ready to be provided by the first queue 122a after the first request 124. Alternatively, when the second request 126 is not a prioritized request and the arbitration logic 114 selects the second request 126 from the second queue 122b, the arbitration logic 114 may not implement (e.g., apply) the third arbitration scheme and may select a next request after the second request 126 using an arbitration scheme other than the third arbitration scheme.

A fourth arbitration scheme may be associated with holding a particular request that is ready to be provided by one of the queues 122a-c. The particular request may be prohibited from being selected by the arbitration logic 114 until a time period associated with the particular request expires. The time period may be based on execution of another request to which the particular request is associated. For example, when the controller 110 receives a read access request (e.g., a read operation) to be performed at the non-volatile memory 130, at least two requests for the non-volatile memory 130 may be generated based on the read access request. The at least two requests may include a sense request (e.g., the first request 124) associated with a sense operation to be performed by the first memory die 132a and a transfer request (e.g. the third request 284) associated with a transfer operation to provide read data based on the first request 124 (e.g., the sense request) as an output of the first memory die 132a. The first request 124 (e.g., the sense request) may be provided to the first memory die 132a along with an address (e.g., a location) of the first memory die 132a. The first memory die 132a may receive the first request 124 and the address and may temporarily store the first request 124 and/or the address at a queue of the first memory die 132a until the first memory die 132a is able to execute the first request 124. Upon execution of the first request 124, the first memory die 132a may sense (e.g., read) data in the first memory die 132a associated with the address and temporarily store the read data at the queue of the first memory die 132a.

After the first request 124 is provided to the first memory die 132a, the first queue 122a may indicate that the third request 284 is ready to be provided to the first memory die 132a. The third request 284 (e.g., the transfer request) may be configured to cause the first memory die 132a to output the read data from the queue of the first memory die 132a after the first request 124 has been executed. Because the third request 284 (e.g., the transfer request) may not be executed until after the first request 124 (e.g., the sense request) has been executed and until after the data has been stored in the queue of the first memory die 132a, the arbitration logic 114 may be prohibited from selecting the third request 284 until a time period associated with the third request 284 has elapsed. For example, the third request 284 may be prohibited from being assigned by the arbitration logic 114 to have access to the shared resource, such as the data path element 140 until after the time period has elapsed. The time period associated with the third request 284 may be based on a duration of time for the first request 124 to complete execution. For example, once the first memory die 132a begins executing the first request 124, the first memory die 132a may provide a signal to the controller 110 indicating that the first request 124 is being executed. Based on the signal, one of the timers 260 may be activated to enable the request detector 116 to determine when the time period associated with the third request 284 has elapsed. When the request detector 116 determines that the time period associated with the third request 284 has elapsed, the third request 284 may be made available (e.g., a hold status may be removed) to be selected by the arbitration logic 114 in accordance with a particular arbitration scheme applied by the arbitration logic 114.

As another example, when the controller 110 receives a write access request (e.g., a write operation) to be performed at the non-volatile memory 130, at least two requests for the non-volatile memory 130 may be generated based on the write access request. The at least two requests may include a program request (e.g., the second request 126) associated with a program (e.g., toggle) operation to be performed by the second memory die 132b of the multiple memory dies 132a-c and a check status request (e.g. the fourth request 286) associated with a check status operation to be performed at the second memory die 132b. The second request 126 (e.g., the program request) may be provided to the second memory die 132b along with an address (e.g., a location) of the second memory die 132b and data to be written to the address. For example, the data to be written (e.g., write data) to the address may be provided to the second memory die 132 from a random access memory (RAM) of the controller 110. The second memory die 132b may receive the second request 126, the address, and/or the write data and may temporarily store the second request 126, the address, and/or the write data at a queue of the second memory die 132b until the second memory die 132b is able to execute the second request 126.

At some point in time after the second request 126 is provided to the second memory die 132b, the second queue 122b may indicate that the fourth request 286 is ready to be provided to the second memory die 132b. The fourth request 286 (e.g., the check status request) may be configured to enable the queue of the second memory die 132 to free the queue for another operation after the second request 126 has been executed. Because the fourth request 286 (e.g., the check status request) may not be executed until after the second request 126 (e.g., the program request) has been executed, the arbitration logic 114 may be prohibited from selecting the fourth request 286 to be provided to the second memory die 132b via the data path element 140 until a time period associated with the fourth request 286 has elapsed. For example, the fourth request 286 may be prohibiting from being assigned by the arbitration logic 114 to have access to the shared resource, such as the data path element 140, until after the time period associated with the fourth request 286 has elapsed. The time period associated with the fourth request 286 may be based on a duration of time for the second request 126 to be executed. For example, once the second memory die 132b begins executing the second request 126, the second memory die 132b may provide a signal to the controller 110 indicating that the second request 126 is being executed. Based on the signal, one of the timers 260 may begin counting to enable the request detector 116 to determine when the time period associated with the fourth request 286 has elapsed. When the request detector 116 determines that the time period associated with the fourth request 286 has elapsed, the fourth request 286 may be made available to be selected by the arbitration logic 114 in accordance with a particular arbitration scheme applied by the arbitration logic 114.

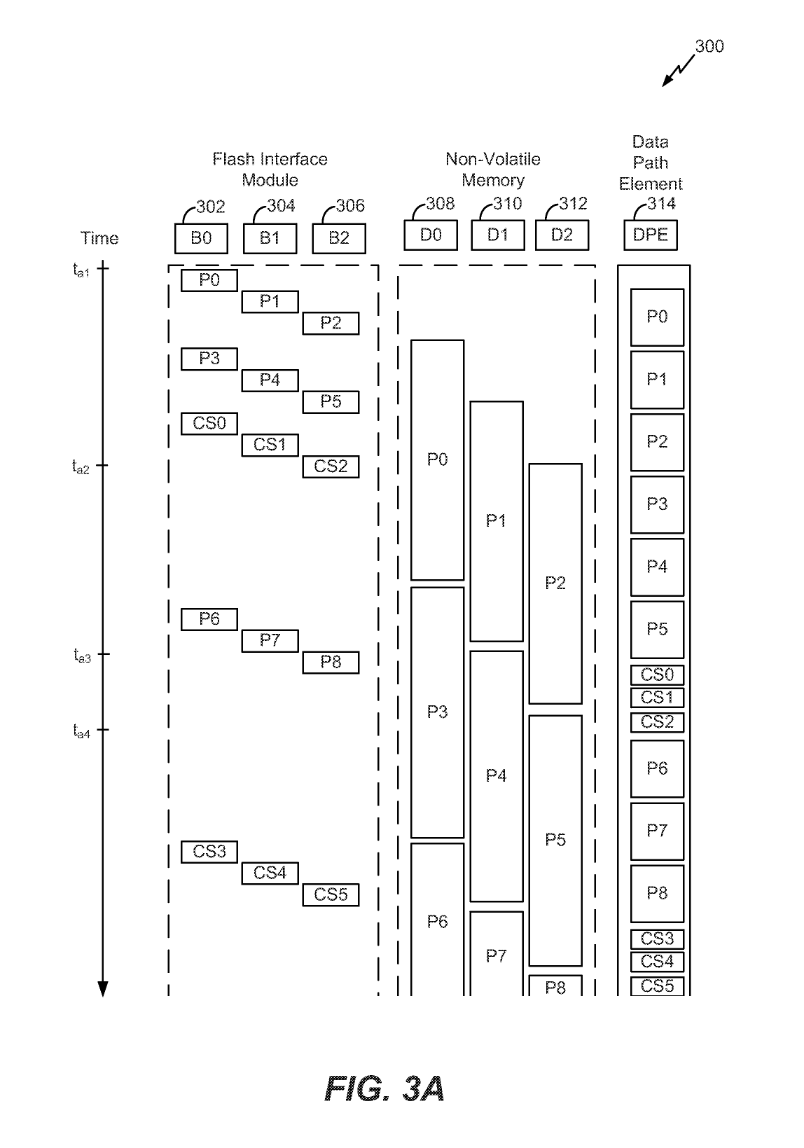

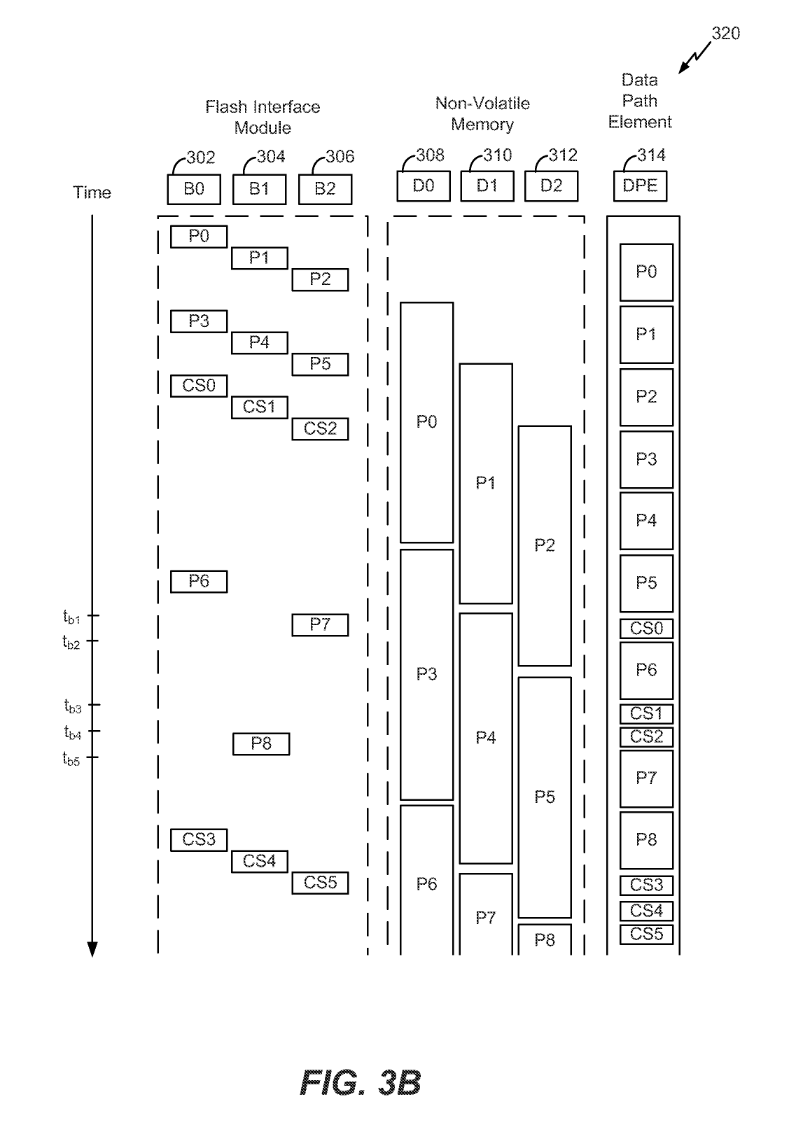

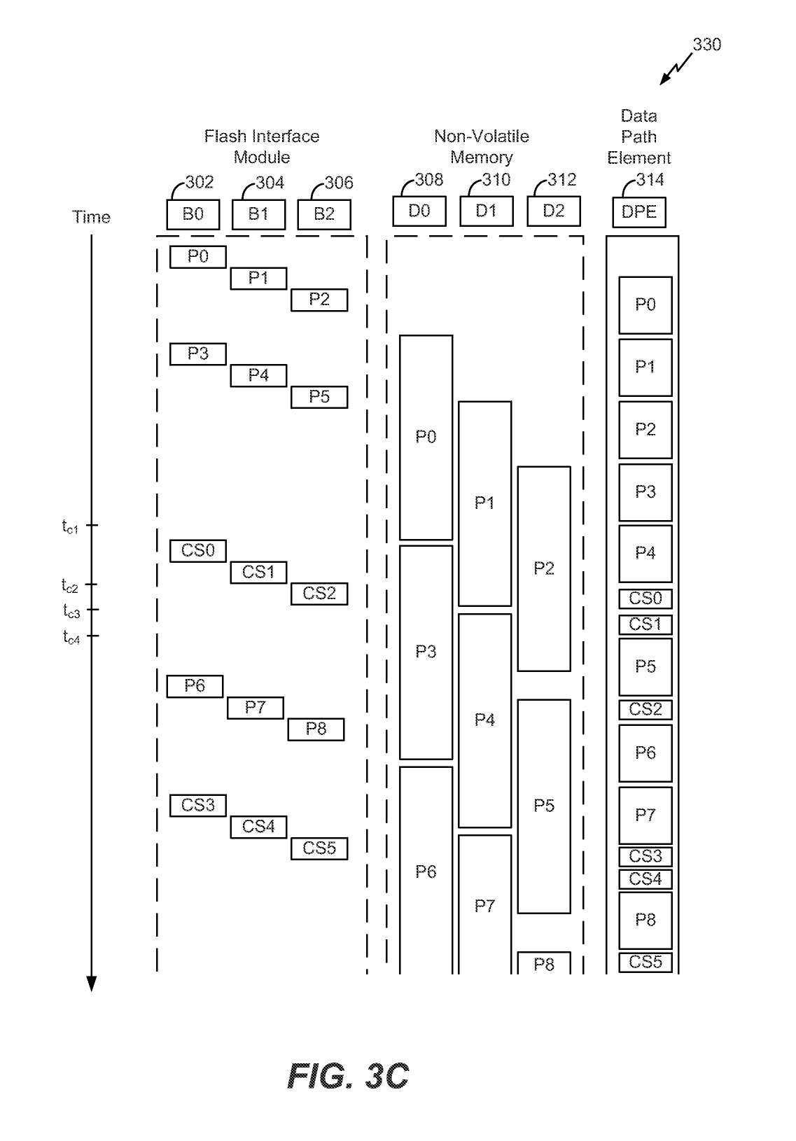

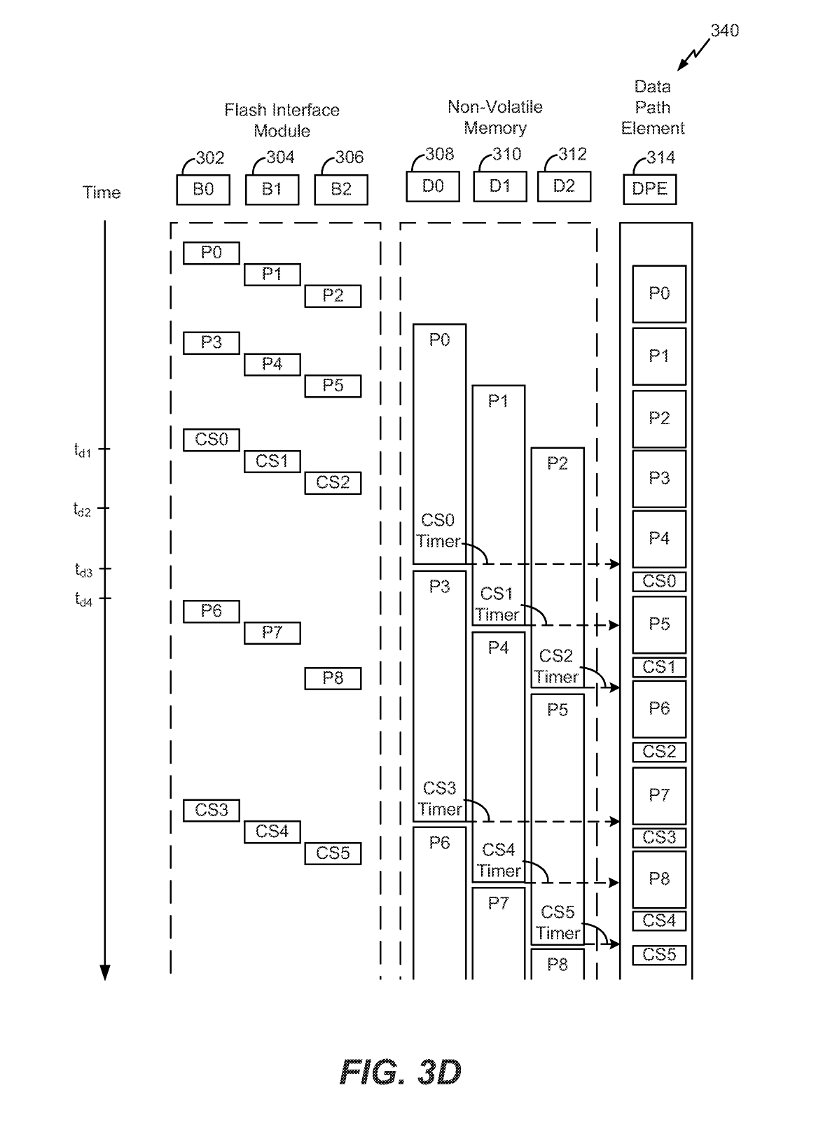

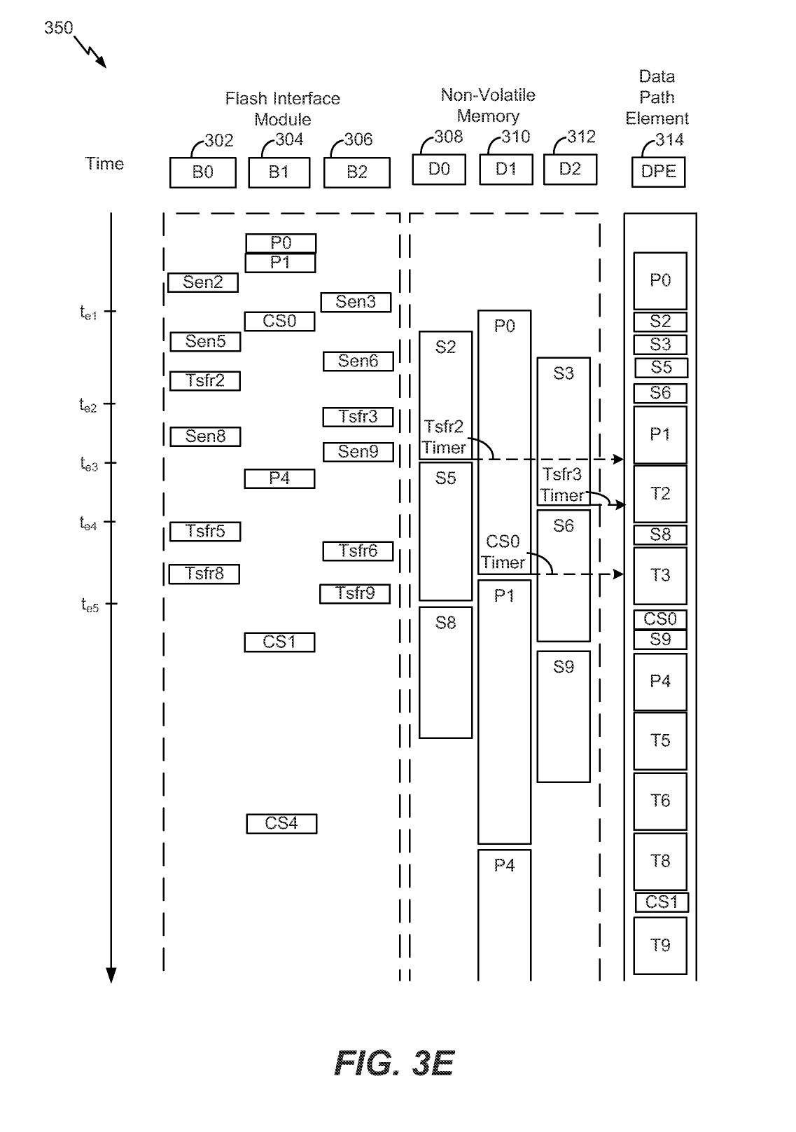

Referring to FIGS. 3A-E, illustrative examples of implementations of different arbitration schemes are depicted. For example, the arbitration schemes may be implemented at a data storage device, such as the data storage device 102 of FIG. 1. Each of FIGS. 3A-E illustrates contents of a flash interface module, operations performed at a non-volatile memory, and requests communicated via a shared resource. The flash interface module, such as the flash interface module 112 of FIG. 1, may include queues 302-306. The queue 302-306 may include a first queue 302, a second queue 304, and a third queue 306, which may correspond to the first queue 122a, the second queue 122b, and the Nth queue 122c, respectively. The non-volatile memory, which may correspond to the non-volatile memory 130 of FIG. 1, may include memory dies 308-312. The memory dies 308-312 may include a first memory die 308, a second memory die 310, and a third memory die 312, which may correspond to the first memory die 132a, the second memory die 132b, and the Nth memory die 132c, respectively. The shared resource may include a data path element 314, such as the data path element 140 of FIG. 1. The data path element 314 may be a bus that couples the flash interface module and the non-volatile memory.

In each of the FIGS. 3A-E, requests provided to the queues 302-306 of the flash interface module may have a corresponding order that is based on an order in which the requests are received by the flash interface module. Requests and operations designated by a letter “P” may be associated with a program request (e.g., a toggle request) and/or a program operation (e.g., a toggle operation). Requests and operations designated by the letters “CS” may be associated with a check status request and/or a check status operation. The check status request may be a prioritized request. Requests and operations designated by the letters “Sen” or “S” may be associated with a sense request and/or a sense operation. The sense request may be a prioritized request. Requests and operations designated by the letters “Tsfr” or “T” may be associated with a transfer request and/or a transfer operation.

Referring to FIG. 3A, a first illustrative example of an implementation of an order number arbitration scheme is depicted and generally designated 300. Using the order number arbitration scheme, arbitration logic, such as the arbitration logic 114, may select requests from the queues 302-308 based on an order number corresponding to each request that is ready to be provided by one of the queues 302-308 at a time of selection.

To illustrate, at time tₐ₁, the first queue 302 may receive a program request P0. After the first queue receives the program request P0, the request P0 may be communicated via the data path element 314 to the first memory die 308. The first memory die 308 may execute the request P0 to perform an operation P0.

At time tₐ₂, requests P0, P1, and P2 may have been communicated to the non-volatile memory via the data path element 314. The first queue 302 may include the requests P3 and CS0 and may be ready to provide the request P3 to the first memory die 308 via the data path element 314. The second queue 304 may include the requests P4 and CS1 and may be ready to provide the request P4 to the second memory die 310 via the data path element 314. The third queue 306 may include the requests P5 and CS2 and may be ready to provide the request P5 to the third memory die 312 via the data path element 314.

At time tₐ₃, requests P3, P4, and P5 may have been communicated to the non-volatile memory via the data path element 314. The first queue 302 may include the requests CS0 and P6 and may be ready to provide the request CS0 to the first memory die 308 via the data path element 314. The second queue 304 may include the requests CS1 and P7 and may be ready to provide the request CS1 to the second memory die 310 via the data path element 314. The third queue 306 may include the request CS2 and may be ready to provide the request CS2 to the third memory die 312 via the data path element 314.

At time tₐ₄, requests CS0, CS1, and CS2 may have been communicated to the non-volatile memory via the data path element 314. The first queue 302 may include and may be ready to provide the request P6. The second queue 304 may include and may be ready to provide the request P7. The third queue 306 may include and may be ready to provide the request P8.

Thus, FIG. 3A illustrates an implementation of an order number arbitration scheme.

Referring to FIG. 3B, a second illustrative example of an implementation of an arbitration scheme is depicted and generally designated 320. When the arbitration scheme is applied by arbitration logic, such as the arbitration logic 114 of FIG. 1, the arbitration logic may select requests based on an order number corresponding to each request that is ready to be provided by one of the queues 302-308 at a time of selection. Additionally, as part of the arbitration scheme, when a particular request (e.g., selected based on a particular order number of the particular request) is a prioritized request, the arbitration logic may determine whether the queue that provided the particular request includes another request that is ready to be provided. If the queue includes another request, the other request may be selected as a next selected request. If the queue does not include another request, arbitration logic may select a next request based on one or more order numbers of requests ready to be provided by the queues 302-306.

To illustrate, at time t_{b1}, requests P0, P1, P2, P3, P4, and P5 may have been communicated to the non-volatile memory via the data path element 314 based on order numbers. The first queue 302 may include the requests CS0 and P6 and may be ready to provide the request CS0 to the first memory die 308 via the data path element 314. The second queue 304 may include the request CS 1 and may be ready to provide the request CS1 to the second memory die 310 via the data path element 314. The third queue 306 may include the request CS2 and may be ready to provide the request CS2 to the third memory die 312 via the data path element 314. Each of the request CS0, CS1, and CS2 may be prioritized requests. Of the requests CS0, CS1, and CS2 that are ready to be provided via the data path element 314, the request CS0 may be the next request selected based on order number after the time t_{b1}.

At time t_{b2}, the request CS0 may have been communicated to the non-volatile memory via the data path element 314 based on an order number of the request CS0. The first queue 302 may include and be ready to provide the request P6. The second queue 304 may include and be ready to provide the request CS1. The third queue 306 may include the requests CS2 and P7 and may be ready to provide the request CS2. Of the requests P6, CS1, and CS2 that are ready to be provided via the data path element 314, the request CS1 would be the next request selected, after the time t_{b2}, based on an order number of the request CS1. However, because the most recent request sent via the data path element 314 was the request CS0 (e.g., a prioritized request) provided from the first queue 302, the request P6 may be the next request selected after the time t_{b2} because the request P6 is ready to be provided and is from the same queue that the request CS0 was provided from.

At time t_{b3}, the request P6 may have been communicated to the non-volatile memory via the data path element 314. The first queue 302 may not include any requests. The second queue 304 may include and be ready to provide the request CS1. The third queue 306 may include the requests CS2 and P7 and may be ready to provide the request CS2. Of the requests CS1 and CS2 that are ready to be provided via the data path element 314, the request CS1 may be the next request selected, after the time t_{b3}, based on order number of the request CS1.

At time t_{b4}, the request CS1 may have been communicated to the non-volatile memory via the data path element 314. The first queue 302 and the second queue 304 may not include any requests. The third queue 306 may include the requests CS2 and P7 and may be ready to provide the request CS2. The request CS2 may be the next request selected, after the time t_{b4}, based on order number of the request CS2.

At time t_{b5}, the request CS2 may have been communicated to the non-volatile memory via the data path element 314. The first queue 302 may not include any requests. The second queue may include and be ready to provide the request P8. The third queue 306 may include and be ready to provide the request P7. The request P7 may be the next request selected after the time t_{b4}. For example, the request P7 may be the next request selected based on an order number of the request P7 and/or based on being ready to be provided from the same queue that the request CS2 (e.g., a prioritized request) was provided from.

FIG. 3B illustrates an implementation of an arbitration scheme where requests are selected to access a shared resource based on an order number corresponding to each request that is ready to be provided by one of the queues 302-308 at a time of selection. However, when a particular request is a prioritized request (e.g., the request CS0) and the queue that provided the prioritized request has another request (e.g., the request P6) that is ready to be provided, the arbitration scheme may select the other request (e.g., the request P6) from the same queue that provided the prioritized request (e.g., the request CS0) regardless of one or more order numbers of requests in other queues that are ready to be provided to the shared resource.

Referring to FIG. 3C, a third illustrative example of an implementation of an arbitration scheme is depicted and generally designated 330. When the arbitration scheme is applied by arbitration logic, such as the arbitration logic 114 of FIG. 1, the arbitration logic may select requests based on an order number corresponding to each request that is ready to be provided by one of the queues 302-308 at a time of selection. Additionally, as part of the arbitration scheme, when one of the requests that is ready to be provided is a prioritized request, the prioritized request may bypass the order number arbitration and may be provided prior to one or more requests that are ready but that are not prioritized requests.

To illustrate, at time t_{c1}, requests P0, P1, P2, and P3 may have been communicated to the non-volatile memory via the data path element 314 based on order numbers. The first queue 302 may include no requests. The second queue 304 may include and be ready to provide the request P4. The third queue 306 may include and be ready to provide the request P5. Of the requests P4 and P5 that are ready to be provided via the data path element 314, the request P4 may be the next request selected, after the time t_{c1}, based on an order number of the request P4.

At time t_{c2}, the request P4 may have been communicated to the non-volatile memory via the data path element 314. The first queue 302 may include and be ready to provide the request CS0 (e.g., a prioritized request). The second queue 304 may include and be ready to provide the request CS1 (e.g., a prioritized request). The third queue 306 may include and be ready to provide the requests P5. Of the requests CS0, CS1, and P5 that are ready to be provided via the data path element 314, the request P5 would be the next request selected, after the time t_{c2}, based on an order number of the request P5. However, because the requests CS0 and CS1 are prioritized requests, the requests CS0 and CS1 may be selected to be provided via the data path element 314 prior to the request P5. CS0 may be selected as the next request selected, after the time t_{c2}, based on order numbers of the prioritized requests CS0 and CS1.

At time t_{c3}, the request CS0 may have been communicated to the non-volatile memory via the data path element 314. The first queue 302 may not include any requests. The second queue 304 may include and be ready to provide the request CS1. The third queue 306 may include the requests P5 and CS2 and may be ready to provide the request P5. Of the requests CS1 and P5 that are ready to be provided via the data path element 314, the request P5 would be the next request selected, after the time t_{c3}, based on an order number of the request P5. However, because the request CS1 is a prioritized request, the request CS1 may be selected to be provided via the data path element 314 prior to the request P5. Accordingly, the request CS1 may be selected as the next request selected after the time t_{c3} because the request CS1 is the prioritized request.

At time t_{c4}, the request CS1 may have been communicated to the non-volatile memory via the data path element 314. The first queue 302 and the second queue 304 may not include any requests. The third queue 306 may include the requests P5 and CS2 and may be ready to provide the request P5. The request P5 may be the next request selected, after the time t_{c4}, based on an order number of the request 135.

FIG. 3C illustrates an implementation of an arbitration scheme that selects requests based on an order number corresponding to each request that is ready to be provided by one of the queues 302-308 at a time of selection. However, when one of the requests that is ready to be provided is a prioritized request (e.g., the request CS0), the prioritized request may bypass the order number arbitration and may be provided (e.g., provided access to a shared resource, such as a data bus) prior to one or more requests that are ready but that are not prioritized requests.

Referring to FIG. 3D, a fourth illustrative example of an implementation of an arbitration scheme is depicted and generally designated 340. When the arbitration scheme is applied by arbitration logic, such as the arbitration logic 114 of FIG. 1, the arbitration logic may select requests based on an order number corresponding to each request that is ready to be provided by one of the queues 302-308. As part of the arbitration scheme, when one of the requests that is ready to be provided is a prioritized request, the prioritized request may bypass the order number arbitration. Additionally, one or more of the requests to be provided by the queues 302-306 may be prohibited from being provided until a corresponding time period has expired. For example, the request CS0 may correspond to the request P0. Accordingly, the request CS0 may be prohibited from being provided from the first queue 302 until a time period expires (e.g., a time period associated with an operation of the request P0). The time period may be determined to be expired based on a timer, such as one of the timers 260 of FIG. 2, that corresponds to the request CS0. Similar relationships may be present between requests CS1 and P1, between requests CS2 and P2, between requests CS3 and P3, between requests CS4 and P4, and/or between requests CS5 and P5, which may prohibit one or more of the requests CS1, CS2, CS3, CS4, and/or CS5 from being provided via the data path element 314, as illustrative non-limiting examples.

To illustrate, at time t_{d1}, requests P0, P1, and P2 may have been communicated to the non-volatile memory via the data path element 314 based on order numbers. The first queue 302 may include the requests P3 and CS0 and may be ready to provide the request P3. The second queue 304 may include and be ready to provide the request P4. The third queue 306 may include and be ready to provide the request P5. Of the requests P3, P4, and P5 that are ready to be provided, the request P3 may be the next request selected, after the time t_{d1}, based on an order number of the request P3.

At time to, the request P3 may have been communicated to the non-volatile memory via the data path element 314. The first queue 302 may include and be ready to provide the request CS0 (e.g., a prioritized request). The second queue 304 may include the requests P4 and CS1 and may be ready to provide the request P4. The third queue 306 may include the requests P5 and CS2 and may be ready to provide the requests P5. Of the requests CS0, P4, and P5 that are ready to be provided via the data path element 314, the request CS0 would be the next request selected after the time to based on being a prioritized request. However, the request CS0 is prohibited from being selected because a time period of the request CS0, that is associated the request P0, has not expired. Accordingly, of the requests P4 and P5 that are available to be selected, the request P4 may be selected as the next request selected after the time to based on order numbers of the requests P4 and P5.

At time to, the request P4 may have been communicated to the non-volatile memory via the data path element 314 and the time period associated with the request CS0 may have expired. The first queue 302 may include and be ready to provide the request CS0 (e.g., a prioritized request). The second queue 304 may include and be ready to provide the request CS1 (e.g., a prioritized request); however, the request CS1 may be prohibited from being selected because a time period of the CS1 associated with the request P1 has not expired. The third queue 306 may include the requests P5 and CS2 and may be ready to provide the requests P5. Of the requests CS0 and P5 that are ready and available to be provided via the data path element 314, the request CS0 would be the next request selected after the time to because the request CS0 is a prioritized request.

At time t_{d4}, the request CS0 may have been communicated to the non-volatile memory via the data path element 314. The first queue 302 may not include any requests. The second queue 304 may include and be ready to provide the request CS1 (e.g., a prioritized request); however, the request CS1 may be prohibited from being selected because the time period associated with the request CS1 has not expired. The third queue 306 may include the requests P5 and CS2 and may be ready to provide the requests P5. The request P5 may be the next request selected, after the time t_{d4}, based on an order number of the request P5 and because the request P5 is the only request ready to be provided.

Between the time t_{d4} and time t_{d5}, the time period associated with CS 1 may have expired. At time t_{d5}, the request P5 may have been communicated to the non-volatile memory via the data path element 314. The first queue 302 may include and be ready to provide the request P6. The second queue 304 may include the requests CS1 and P7 and may be ready to provide the request CS 1 (e.g., a prioritized request). The third queue 306 may include and be ready to provide the request CS2; however, the request CS2 may be prohibited from being selected because a time period associated with the request CS2 has not expired. Of the requests P6 and CS1 that are ready and available to be selected to be provided, the request CS1 would be the next request selected, after the time t_{d4}, because the request CS1 is a prioritized request.

FIG. 3D illustrates an implementation of an arbitration scheme that selects requests based on an order number corresponding to each request that is ready to be provided by one of the queues 302-308 at a time of selection. However, when one of the requests that is ready to be provided is a prioritized request, the prioritized request may bypass the order number arbitration and may be provided prior to one or more requests that are ready but that are not prioritized requests. Additionally, FIG. 3D further illustrates that a prioritized request (e.g., the request CS0) may be prohibited from being provided until a corresponding time period has expired.

Referring to FIG. 3E, a fifth illustrative example of an implementation of an arbitration scheme is depicted and generally designated 350. When the arbitration scheme is applied by arbitration logic, such as the arbitration logic 114 of FIG. 1, the arbitration logic may select requests based on an order number corresponding to each request that is ready to be provided by one of the queues 302-308 at a time of selection. As part of the arbitration scheme, when one of the requests that is ready to be provided is a prioritized request, the prioritized request may bypass the order number arbitration and may be provided prior to one or more request that are ready but that are not prioritized requests. Additionally, one or more of the requests to be provided by the queues 302-308 may be prohibited from being provided until a corresponding time period has expired. For example, the request CS0 may correspond to the request P0. Accordingly, the request CS0 may be prohibited from being provided from the first queue 302 until a time period expires (e.g., a time period associated with execution of the request P0. Similar relationships may be present between requests CS1 and P1, between requests CS4 and P4, between requests Sen2 and Tsfr2, between requests Sen3 and Tsfr3, between requests Sen5 and Tsfr5, between requests Sen6 and Tsfr6, between requests Sen8 and Tsfr8, and/or between requests Sen9 and Tsfr9, which may prohibit one or more of requests CS1, CS4, Tsfr2, Tsfr3, Tsfr5, Tsfr6, Tsfr8, and/or Tsfr9 from being provided via the data path element 314, as illustrative, non-limiting examples.

To illustrate, at time t_{c1}, request P0 may have been communicated to the non-volatile memory via the data path element 314. The first queue 302 may include and be ready to provide the request Sen2 (e.g., a prioritized request). The second queue 304 may include and be ready to provide the request P1. The third queue 306 may include and be ready to provide the request Sen3 (e.g., a prioritized request). Of the requests Sen2, P1, and Sen3, the requests Sen2 and Sen3 are prioritized requests. Of the requests Sen2 and Sen3 that are the prioritized requests and are ready to be provided via the data path element 314, the request Sen2 may be the next request selected, after the time t_{c1}, based on an order number of the request Sen2.

At time t_{c2}, the requests Sen2, Sen3, Sen5, and Sen6 may have been communicated to the non-volatile memory via the data path element 314. The first queue 302 may include and be ready to provide the request Tsfr2. The second queue 304 may include the requests P1 and CS0 and may be ready to provide the request P1. The third queue 306 may include no requests. Of the requests Tsfr2 and P1 that are ready to be provided via the data path element 314, the request P1 may be the next request selected, after the time t_{c2}, based on an order number of the request P1. It is noted, that at the time t_{c2}, the request Tsfr2 is prohibited from being selected because a time period of the request Tsfr2 has not expired.

Between the time t_{c2} and time t_{c3}, the time period associated with Tsfr2 may have expired. At time t_{c3}, the request P1 may have been communicated to the non-volatile memory via the data path element 314. The first queue 302 may include the requests Tsfr2 and Sen8 and may be ready to provide the request Tsfr2. The second queue 304 may include and be ready to provide the request CS0 (e.g., a prioritized request); however, the request CS0 may be prohibited from being selected because a time period of the CS0 has not expired. The third queue 306 may include the requests Tsfr3 and Sen9 and may be ready to provide the request Tsfr3; however, the request Tsfr3 may be prohibited from being selected because a time period of the Tsfr3 has not expired. The request Tsfr2 may be the next request selected after the time t_{c2} based on an order number of the request Tsfr2 and because the request Tsfr2 is the only request ready and available to be provided.

Between the time tea and time t_{c4}, the time period associated with Tsfr3 may have expired. At time t_{c4}, the request Tsfr2 may have been communicated to the non-volatile memory via the data path element 314. The first queue 302 may include and be ready to provide the request Sen8 (e.g., a prioritized request). The second queue 304 may include the requests CS0 and P4 and may be ready to provide the request CS0 (e.g., a prioritized request). However, the request CS0 may be prohibited from being selected because a time period of the CS0 has not expired. The third queue 306 may include the requests Tsfr3 and Sen9 and may be ready to provide the request Tsfr3. Of the requests Sen8 and Tsfr3 that are ready and available to be provided via the data path element 314, the request Sen8 may be the next request selected, after the time t_{c4}, based on being a prioritized request.

Between the time t_{c4} and time t_{c5}, the time period associated with CS0 may have expired. At time t_{c5}, the requests Sen8 and Tsfr3 may have been communicated to the non-volatile memory via the data path element 314. The first queue 302 may include the requests Tsfr5 and Tsfr8 and may be ready to provide the request Tsfr5. The second queue 304 may include the requests CS0 and P4 and may be ready to provide the request CS0 (e.g., a prioritized request). The third queue 306 may include the requests Sen9, Tsfr6, and Tsfr9 and may be ready to provide the request Sen9 (e.g., a prioritized request). Of the requests Tsfr5, CS0, and Sen9 that are ready and available to be provided via the data path element 314, the requests CS0 may be the next request selected, after the time t_{c4}, based on being a prioritized request and based on the order numbers of the requests CS0 and Sen9.

FIG. 3E illustrates an implementation of an arbitration scheme that selects requests based on an order number corresponding to each request that is ready to be provided by one of the queues 302-308 at a time of selection. However, when one of the requests that is ready to be provided is a prioritized request, the prioritized request may bypass the order number arbitration and may be provided prior to one or more requests that are ready but that are not prioritized requests. Additionally, FIG. 3E further illustrates that a prioritized request (e.g., the request CS0) may be prohibited from being provided until a corresponding time period has expired.

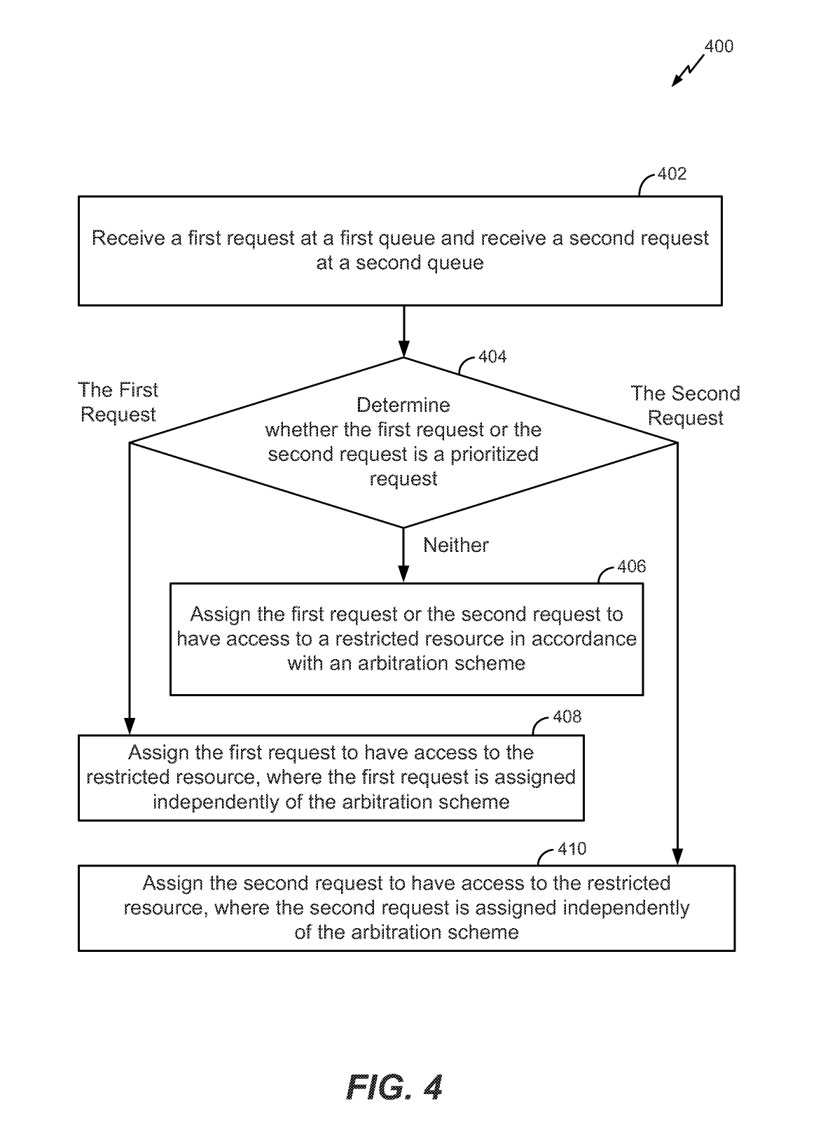

FIG. 4 illustrates a particular embodiment of a method 400 that may be performed at a data storage device, such as the data storage device 102 of FIG. 1. For example, the method 400 may be performed by the controller 110 and/or the arbitration logic 114 of FIGS. 1-2.

The method 400 includes receiving a first request at a first queue and receiving a second request at a second queue, at 402. For example, the first request and the first queue may correspond to the first request 124 and the first queue 122a of FIG. 1, respectively. As another example, the second request and the second queue may correspond to the second request 126 and the second queue 122b of FIG. 1, respectively.

The method 400 also includes determining whether the first request or the second request is a prioritized request (e.g., a request having a flag set to indicate that the second request is prioritized), at 404. The prioritized request may be associated with an arbitration bypass indicator. A determination of whether the first request or the second request is a prioritized request may be made by a request detector, such as the request detector 116 of FIG. 1. The first request may include the arbitration bypass indicator, such as the indicator 104 (e.g., which is set to a value of logical one) of FIG. 1, when the first request is a prioritized request. The second request may include the arbitration bypass indicator, such as the indicator 106 of FIG. 1, when the second request is a prioritized request. The arbitration bypass indicator may be associated with the first request based on a first amount of time that is needed to communicate the first request to a non-volatile memory via a shared resource. For example, the shared resource may include or correspond to the data path element 140 of FIG. 1.

When neither the first request nor the second request is associated with a prioritized request, the method 400 may include assigning the first request or the second request to have access to a restricted resource in accordance with an arbitration scheme, at 406. The arbitration scheme may include one of a greedy algorithm scheme, a first in, first out scheme, a round robin scheme, a static priority scheme, a dynamic priority scheme, a time slicing scheme, an order number scheme, or a bus utilization scheme, as illustrative, non-limiting examples, as illustrative, non-limiting examples. For example, the arbitration scheme may be an order number scheme. The first request may include a first order number of a sequential order, such as the first order number 144 of FIG. 1, and the second request may include a second order number of a sequential order, such as the second order number 146 of FIG. 1. When the first order number has a lower numerical value than the second order number (indicating that, in a sequential order, the first request is prior to the second request), the order number scheme may determine that the first request is assigned to have access to the restricted resource prior to the second request. Alternatively, when the second order number has a lower numerical value than the first order number, the order number scheme may determine that the second request is assigned to have access to the restricted resource prior to the first request.

When the first request is associated with a prioritized request, the method 400 may include assigning the first request to have access to the restricted resource, where the first request is assigned independently of the arbitration scheme, at 408. When the first request is a prioritized request (e.g., the first request is associated with an arbitration bypass indicator), a mode selector may place arbitration logic in a bypass mode that is independent of the arbitration scheme (e.g., the order number scheme) and the arbitration logic may select the first request regardless of an order number of the first request. For example, when the first request is a prioritized request and the second request is not a prioritized request, the first request is assigned to have access to the restricted resource prior to the second request (regardless of the first order number and the second order number). The mode selector may include or correspond to the mode selector 118 of FIG. 1.

When the second request is associated with the prioritized request, the method 400 may include assigning the second request to have access to the restricted resource, where the second request is assigned independently of the arbitration scheme, at 410. When the second request is a prioritized request (e.g., the second request is associated with an arbitration bypass indicator), the mode selector may place arbitration logic in a bypass mode that is independent of the arbitration scheme (e.g., the order number scheme) and the arbitration logic may select the second request regardless of an order number of the first request. For example, when the second request is a prioritized request and the first request is not a prioritized request, the second request is assigned to have access to the restricted resource prior to the first request (regardless of the first order number and the second order number). The arbitration logic may include or correspond to the arbitration logic 114 of FIG. 1.

Additionally or alternatively, when the first request and the second request are associated with a prioritized request, the method 400 may include assigning the first request or the second request to have access to a restricted resource based on the first order number associated with the first request and based on the second order number associated with the second request. For example, when the first order number has a lower numerical value than the second order number, the first request may be assigned to have access to the restricted resource prior to the second request. Alternatively, when the second order number has a lower numerical value than the first order according to the sequential order, the second request may be assigned to have access to the restricted resource prior to the first request.

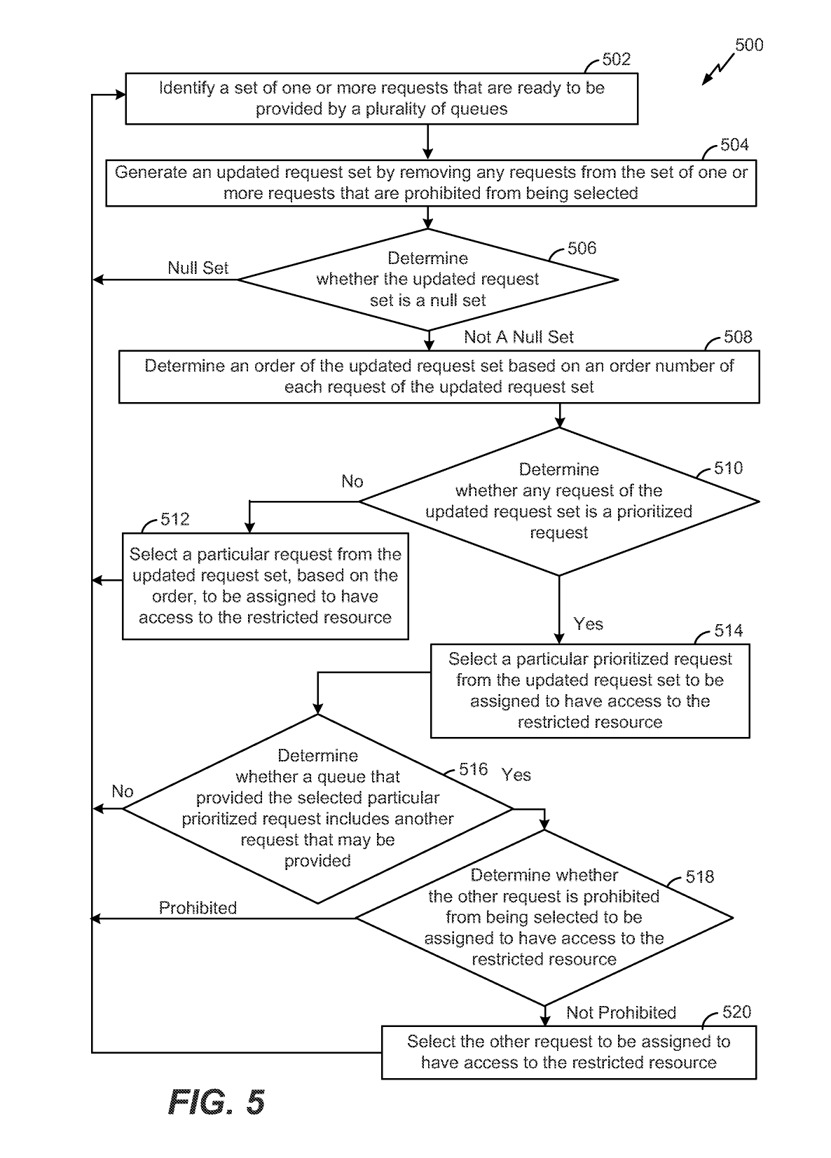

FIG. 5 illustrates a particular embodiment of a method 500 that may be performed at a data storage device, such as the data storage device 102 of FIG. 1. For example, the method 500 may be performed by the controller 110 and/or the arbitration logic 114 of FIGS. 1-2. The method 500 may be associated with an arbitration scheme, such as an arbitration scheme included in the one or more arbitrations schemes 120 of FIGS. 1 and 2.

The method 500 may include identifying a set of one or more requests that are ready to be provided by a plurality of queues, at 502. The set of one or more requests may be ready to be provided to access a restricted resource, such as the data path element 140 of FIG. 1. For example, the plurality of queues may include the queues 122a-c of FIG. 1.

The method 500 may also include generating an updated request set by removing any request from the set of one or more requests that are prohibited from being selected, at 504. A particular request may be prohibited from being selected based on a timer, such as one of the timers 260 of FIG. 2, associated with the particular request. For example, a request detector, such as the request detector 116 of FIG. 1, may identify one or more requests that are prohibited from being selected.

The method 500 may further include determining whether the updated request set is a null set, at 506. For example, the arbitration logic, such as the arbitration logic 114 of FIG. 1, may determine whether the updated request set is the null set. Based on the updated request set being determined to be the null set, processing may advance to 502. Based on the updated request set being determined to not be the null set, the method 500 may further include determining an order of the updated request set based on an order number of each request of the updated request set, at 508.

The method 500 may further include determining whether any request of the updated request set is a prioritized request, at 510. For example, the request detector may determine whether one or more request is a prioritized request. Based on a determination that none of the requests of the updated request set is a prioritized request, the method 500 may include selecting a particular request from the updated request set to be assigned to have access to the restricted resource, at 512. For example, the arbitration logic may select the particular request. The particular request may be selected based on the order. The particular request may be selected and provided to the restricted resource, such as the data path element 140 of FIG. 1. After the particular request is selected, processing may advance to 502.

Based on a determination that at least one request of the updated request set is a prioritized request, the method 500 may include selecting a particular prioritized from the updated request set to be assigned to have access to the restricted resource, at 514. For example, the arbitration logic may select the particular prioritized request. When the set of requests includes multiple prioritized requests, the particular prioritized request may be selected based on the order.

The method 500 may further include determining whether a queue that provided the selected particular prioritized request includes another request that may be provided, at 516. For example, the request detector may determine whether the queue includes another request that may be provided. Based on a determination that the queue does not include another request that may be provided, processing may advance to 502. Based on a determination that the queue does include another request that may be provided, the method 500 may also include determining whether the other request is prohibited from being selected to be assigned to have access to the restricted resource, at 518.

Based on a determination that the other request is prohibited from being provided, processing may advance to 502. Based on a determination that the other request is not prohibited from being provided, the method 500 may further include selecting the other request to be assigned to have access to the restricted resource, at 520. For example, the arbitration logic may select the other request to be assigned to have access to the restricted resource. The other request may be selected regardless of the order. The other request may be selected and provided to the restricted resource, such as the data path element 140 of FIG. 1. After the other request is selected, processing may advance to 502.

The method 400 of FIG. 4 and/or the method 500 of FIG. 5 may be initiated or controlled by a field-programmable gate array (FPGA) device, an application-specific integrated circuit (ASIC), a processing unit, such as a central processing unit (CPU), a digital signal processor (DSP), a controller, another hardware device, a firmware device, or any combination thereof. As an example, the method 400 of FIG. 4 and/or the method 500 of FIG. 5 can be initiated or controlled by one or more processors include in or coupled to the data storage device 102 of FIG. 1.

A controller configured to perform the method 400 of FIG. 4 and/or the method 500 of FIG. 5, may be able to advantageously arbitrate access of a shared resource among multiple threads to efficiently utilize the shared resource. Although various components of the data storage device 102 depicted herein are illustrated as block components and described in general terms, such components may include one or more microprocessors, state machines, or other circuits configured to enable the controller 110 of FIG. 1 to receive a first request at a first queue and to receive a second request at a second queue. Alternatively or additionally, the components may include one or more microprocessors, state machines, or other circuits configured to enable the controller 110 of FIG. 1 to determine whether the first request or the second request is a prioritized request associated with an arbitration bypass indicator. For example, the controller 110 may represent physical components, such as hardware controllers, state machines, logic circuits, or other structures, to enable the controller 110 of FIG. 1 to, when the first request is the prioritized request (and the second request is not the prioritized request, assign the first request to have access to a restricted resource. The first request may be assigned independent of an arbitration scheme. As another example, the controller 110 may represent physical components, such as hardware controllers, state machines, logic circuits, or other structures, to enable the controller 110 of FIG. 1 to, when the second request is the prioritized request (and the first request is not the prioritized request, assign the second request to have access to the restricted resource. The second request may be assigned independent of the arbitration scheme. As a further example, the controller 110 may represent physical components, such as hardware controllers, state machines, logic circuits, or other structures, to enable the controller 110 of FIG. 1 to, when neither the first request or the second request is the prioritized request, assign the first request or the second request to have access to a restricted resource based on the arbitration scheme.

The controller 110 of FIG. 1 may be implemented using a microprocessor or microcontroller programmed to perform the method 400 of FIG. 4 and/or the method 500 of FIG. 5. In a particular embodiment, the microprocessor or the microcontroller is programmed to receive a first request at a first queue and to receive a second request at a second queue. The microprocessor or microcontroller may further be programmed to determine whether the first request or the second request is a prioritized request. The microprocessor or microcontroller may further be programmed to, when the first request is the prioritized request (and the second request is not the prioritized request, assign the first request to have access to a restricted resource. The first request may be assigned independently of an arbitration scheme. The microprocessor or microcontroller may further be programmed to, when the second request is the prioritized request (and the first request is not the prioritized request, assign the second request to have access to the restricted resource. The second request may be assigned independently of the arbitration scheme. The microprocessor or microcontroller may also be programmed to, when neither the first request nor the second request is the prioritized request, assign the first request or the second request to have access to a restricted resource based on the arbitration scheme.

In a particular embodiment, the controller includes a processor executing instructions that are stored at the non-volatile memory 134. Alternatively, or in addition, executable instructions that are executed by the processor may be stored at a separate memory location that is not part of the non-volatile memory 130, such as at a read-only memory (ROM).

In a particular embodiment, the data storage device 102 may be a portable device configured to be selectively coupled to one or more external devices. For example, the data storage device 102 may be a removable device such as a Universal Serial Bus (USB) flash drive or a removable memory card, as illustrative examples. However, in other embodiments, the data storage device 102 may be attached to, or embedded within, one or more host devices, such as within a housing of a portable communication device. For example, the data storage device 102 may be within a packaged apparatus such as a wireless telephone, a personal digital assistant (PDA), a gaming device or console, a portable navigation device, a computer device, or other device that uses internal non-volatile memory. In a particular embodiment, the non-volatile memory 130 includes a flash memory (e.g., NAND, NOR, Multi-Level Cell (MLC), Divided bit-line NOR (DINOR), AND, high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Accordingly, the disclosure and the figures are to be regarded as illustrative rather than restrictive.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. Accordingly, the disclosure and the figures are to be regarded as illustrative rather than restrictive.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data storage device comprising:
a non-volatile memory;
a data path element; and
a controller coupled to the non-volatile memory via the data path element,
wherein the controller includes:
a first queue that includes a first set of requests;
a second queue that includes a second set of requests; and
logic configured to assign a particular request from the first queue or from the second queue to have access to the data path element, wherein the logic in a first mode selects the particular request based on an arbitration scheme, wherein, in a second mode, a prioritized request is selected from the first set of requests or the second set of requests independently of the arbitration scheme.

2. The data storage device of claim 1, wherein the second mode includes a bypass mode.

3. The data storage device of claim 1, wherein the first set of request and the second set of requests include memory bus requests.

4. The data storage device of claim 1, wherein the prioritized request is indicated by an arbitration bypass indicator associated with the prioritized request, and wherein the controller is configured to set the arbitration bypass indicator associated with the prioritized request.

5. The data storage device of claim 1, wherein the arbitration scheme is a greedy algorithm scheme, a first in, first out (FIFO) scheme, a round robin scheme, a static priority scheme, a dynamic priority scheme, or a time slicing scheme.

6. The data storage device of claim 1, wherein the controller is configured to indicate one or more requests as prioritized requests to increase a performance characteristic of the data path element, and wherein each of the one or more request are short bus transactions.

7. The data storage device of claim 8, wherein the short bus transactions include a read command, a check status command, or an erase command.

8. The data storage device of claim 1, wherein the first queue is a priority queue, and wherein each request of the first set of requests is associated with a corresponding order number.

9. The data storage device of claim 1, wherein the arbitration scheme is configured to select the particular request based on a first order number associated with a first request of the first set of requests and based on a second order number associated with a second request of the second set of requests, wherein the first queue is ready to provide the first request, and wherein the second queue is ready to provide the second request.

10. The data storage device of claim 1, wherein, in the second mode the logic is configured to select the prioritized request as one of a first prioritized request of the first set of requests and a second prioritized request of the second set of requests, and wherein one of the first prioritized request or the second prioritized request is selected based on a first order value of the first prioritized request and based on a second order value of the second prioritized request.

11. The data storage device of claim 1, wherein the non-volatile memory includes multiple flash memory dies.

12. A method comprising:
in a data storage device including a controller,
performing:
receiving a first request at a first queue;
receiving a second request at a second queue;
determining whether the first request or the second request is a prioritized request;
when the first request is the prioritized request, assigning the first request to have access to a restricted resource, wherein the first request is assigned independently of an arbitration scheme,
when the second request is the prioritized request, assigning the second request to have access to the restricted resource, wherein the second request is assigned independently of the arbitration scheme; and
when the first request and the second request are unprioritized requests, assigning the first request or the second request to have access to the restricted resource in accordance with the arbitration scheme.

13. The method of claim 12, wherein the restricted resource is included within the data storage device.

14. The method of claim 12, wherein the restricted resource is a data path element.

15. The method of claim 12, further comprising, when the first request and the second request are prioritized requests, assigning one of the first request or the second request to have access to the restricted resource based on a first order value of the first request and based on a first second order value of the second request.

16. The method of claim 12, further comprising:
identifying whether the first request is associated with a timer;
when the first request is associated with the timer, determining whether the timer is expired; and
prohibiting the first request from being assigned to have access to the restricted resource until the timer expires.

17. The method of claim 12, wherein the first request includes a first order number, and wherein, when the first request is a first priority request, the first request includes a first arbitration bypass indicator.

18. The method of claim 12, wherein the second request includes a second order number, and wherein, when the second request is a second priority request, the second request includes a second arbitration bypass indicator.

19. The method of claim 12, wherein the restricted resource is a bus coupled between the controller and a non-volatile memory.

20. The method of claim 19, wherein the non-volatile memory includes a flash memory.

21. The method of claim 12, wherein the prioritized request is associated with an arbitration bypass indicator.
